(19) United States
(12) Patent Application Publication
(10) Pub. No.: US 2003/0232237 A1
(43) Pub. Date: Dec. 18, 2003

(54) Voltage control apparatus for battery pack

(75) Inventors: Toyoaki Nakagawa, Chigasaki-shi (JP); Makoto Iwashima, Yokosuka-shi (JP); Tetsuya Niikuni, Yokosuka-shi (JP)

Correspondence Address: McDERMOTT, WILL & EMERY, 600 13th Street, N.W., Washington, DC, 20005-3096, US

(73) Assignee: NISSAN MOTOR CO,. LTD.

(21) Appl. No.: 10/454,681

(22) Filed: Jun. 5, 2003

(30) Foreign Application Priority Data
Jun. 12, 2002 (JP) 2002-171170

(51) Int. Cl. H01M 10/42

(52) U.S. Cl. 429/61

(57) ABSTRACT

The voltage detection circuits each detect the terminal voltage of the corresponding cell and output a detection signal accordingly. Current bypass circuits are each provided in parallel to one of the cells. The voltage detection signal from a given voltage detection circuit is input to the corresponding current bypass circuit. If the cell terminal voltage at any cell reaches a first target voltage which is slightly lower than the voltage corresponding to SOC 100% while the battery pack 1 is charged, the current bypass circuit bypasses the charge current to the cell. As the cell terminal voltage reaches a second target voltage corresponding to SOC to 50%, the current bypass circuit bypasses the charge current to the cell. The current bypass circuit selectively switches over to one of the target voltages.

### BACKGROUND OF THE INVENTION

1. Field of the invention

The present invention relates to battery pack voltage control apparatus.

2. Related Art

There is a technology in the known art which is adopted to drive an electric load by using a battery pack constituted of a plurality of chargeable cells as a power source. The battery pack repeatedly executes a discharge operation to drive the load and a charge operation to recharge the cells. Voltage control is implemented in such a battery pack in order to minimize the inconsistency among terminal voltages at the cells constituting the battery pack by detecting the terminal voltages at the individual cells. For instance, Japanese Laid-Open Patent Publication No. 2001-190030 discloses a technology for achieving uniformity among the terminal voltages at the individual cells by connecting in parallel a balance circuit to each of the cells and partially bypassing the charge current with these balance circuits. As the terminal voltage at a given cell reaches a predetermined value, the corresponding balance circuit bypasses the charge current at the cell. Since the charge current supplied to the cell is lowered if the charge current is bypassed and thus slows down the process of the cell reaching a fully charged state, the extent of the inconsistency between the terminal voltage at this cell and the terminal voltages at the other cells which do not reach a fully charged stage as quickly is reduced.

### SUMMARY OF THE INVENTION

In a system such as a hybrid electric vehicle, a battery is normally used in a state in which it is charged to approximately 50% and the voltage of the battery mounted in such a system fluctuates in correspondence to its state of charge. For this reason, if control is implemented to minimize the inconsistency among the voltages at the individual cells based upon a voltage level corresponding to a nearly fully charged state, the charge currents are not bypassed as often as they should be during the actual operation and, as a result, the voltages at the cells cannot be controlled to achieve uniformity with ease.

The present invention is to provide an apparatus for controlling a battery pack voltage so as to minimize inconsistency among the voltages at cells in conformance to the state of charges of the cells.

A voltage control apparatus that controls a voltage of a battery pack constituted of a plurality of cells according to the present invention, comprises a plurality of voltage detection devices each detecting a voltage at each of the cells; a plurality of first voltage adjustment devices each adjusting the voltage at each cell so as to achieve a first target value based upon the each voltage value detected by each of the voltage detection devices; and a plurality of second voltage adjustment devices each adjusting the voltage at each cell so as to achieve a second target value based upon the each voltage value detected by each of the voltage detection devices.

A voltage control apparatus that controls a voltage of a battery pack constituted of a plurality of cells according to another aspect of the present invention, comprises a plurality of first circuits each constituted of a first Zener diode having a first breakdown voltage and a first resister connected to the first Zener diode; and a plurality of second circuits each constituted of a second Zener diode having a second breakdown voltage smaller than the first breakdown voltage and a second resister connected to the second Zener diode. The individual first and second series circuits are connected in parallel to each cell and connected in parallel to each other.

### BRIEF DESCRIPTION OF THE DRAWINGS

FIG. 1 is an overall structure of a vehicle mounted with a battery pack voltage control apparatus achieved in the first embodiment of the present invention

FIG. 2 is a circuit block diagram of a current bypass circuit

FIG. 3 is the relationship between the cell SOC and the cell terminal voltage

FIG. 4 is a circuit block diagram of a current bypass circuit achieved in the second embodiment

FIG. 5 is a circuit block diagram of a current bypass circuit achieved in the third embodiment

### DESCRIPTION OF THE PREFEREED EMBODIMENTS

The following is an explanation of preferred embodiments of the present invention, given in reference to the drawings.

### First Embodiment

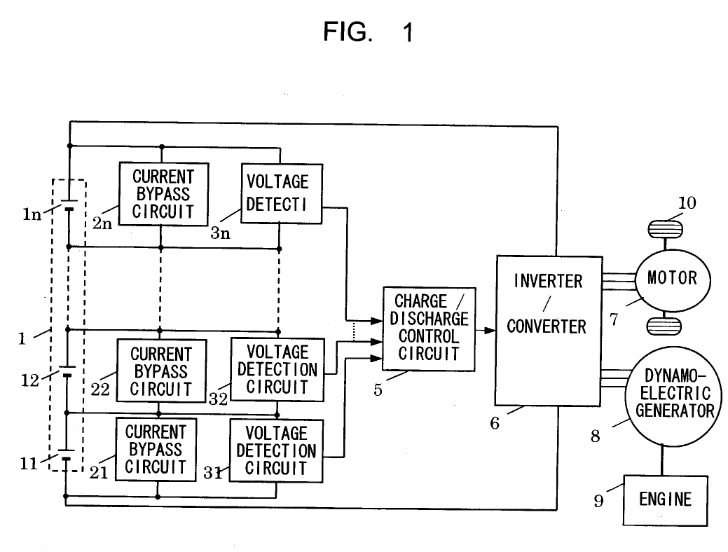

FIG. 1 is an overall block diagram of a vehicle mounted with a battery pack voltage control apparatus achieved in the first embodiment of the present invention. In the embodiment, a battery pack is utilized as a power source in a hybrid electric vehicle. In FIG. 1, a battery pack 1 is constituted by connecting in series n cells 11˜1n. A voltage control apparatus includes current bypass circuits 21˜2n and voltage detection circuits 31˜3n.

The battery pack 1 supplies a current to an inverter/converter 6 during a discharge. The inverter/converter 6 controls a power output to a motor 7 in response to a command issued by a charge/discharge control circuit 5. The motor 7 drives wheels 10. Through the output control implemented by the inverter/converter 6, a load current of the battery pack 1 is controlled. The battery pack 1 is charged with a current supplied from the inverter/converter 6 during a charge operation. The inverter/converter 6 controls the charge current supplied to the battery pack 1 in response to a command issued by the charge/discharge control circuit 5. A dynamo-electric generator 8, which is driven by a gasoline engine 9, generates electric power and supplies to the inverter/converter 6.

The charge/discharge control circuit 5 calculates a charge current value and a discharge current (load current) value for the battery pack 1 by using voltage data of the battery pack 1 detected by the voltage detection circuits 31˜3n, and outputs a charge control value and a discharge control value to be referenced to achieve these charge and discharge current values to the inverter/converter 6. It is to be noted that when the vehicle travels, the actual control values of electric power are calculated by using detection values provided by various sensors (not shown) such as an accelerator operation quantity sensor and a brake operation quantity sensor in addition to the voltage data.

The voltage detection circuits 31˜3n are respectively provided in parallel to the cells 11˜1n. The voltage detection circuits 31˜3n may each be constituted of, for instance, a differential amplifier circuit. The voltage detection circuits 31˜3n each detect the terminal voltage of the corresponding cell to which it is connected in parallel while the battery pack 1 is charged or discharged and output a detection signal. The current bypass circuits 21˜2n are provided in parallel to the cells 11˜1n respectively. The voltage detection signals from the voltage detection circuits 31˜3n are input to the current bypass circuits 21˜2n respectively.

If any of the voltage values indicated by the voltage detection signals input from the voltage detection circuits 31˜3n while the battery pack 1 is charged reaches a decision-making threshold value which is lower than a charge end voltage by a predetermined value, the corresponding current bypass circuit 21˜2n bypasses the charge current at the corresponding cell into the bypass circuit. As a result, the charge current flowing into the cell is lowered, slowing down the speed at which the cell reaches a fully charged state, i.e., a state of charge (SOC) equivalent to 100%. The charge end voltage is the terminal voltage corresponding to SOC 100% at the cell.

The present invention is characterized by the current bypass circuits 21˜2n constituting the voltage control apparatus described above.

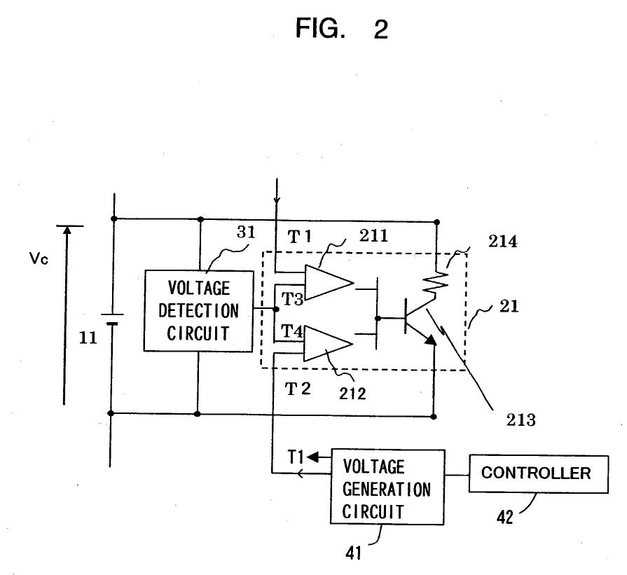

FIG. 2 is a circuit block diagram illustrating the current bypass circuit 21 achieved in the first embodiment. In FIG. 2, the voltage detection circuit 31 and the current bypass circuit 21 are connected in parallel to the cell 11. Voltage detection circuits and current bypass circuits identical to those shown in FIG. 2 are connected to the other cells. The current bypass circuit 21 includes a first voltage comparator circuit 211, a second voltage comparator circuit 212, a transistor 213 and a resistor 214.

A first target voltage V1 is applied by a voltage generator circuit 41 to a reference terminal T1 of the first voltage comparator circuit 211. The target voltage V1 is slightly lower than the terminal voltage at the cell corresponding to a fully charged state (SOC 100%). A second target voltage V2 is applied by the voltage generator circuit 41 to a reference terminal T2 of the second voltage comparator circuit 212. The target voltage V2 is set at the value of the terminal voltage at the cell corresponding to SOC 50%.

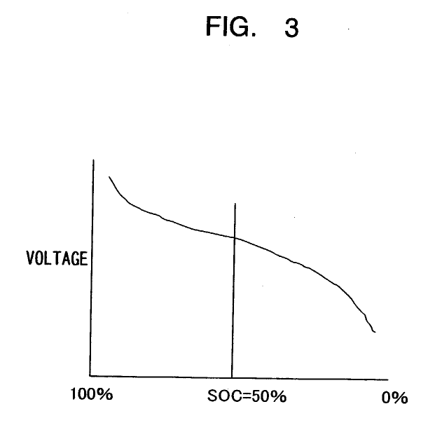

FIG. 3 shows an example of the relationship achieved between the cell SOC and the cell terminal voltage. In FIG. 3, the horizontal axis represents the state of charge at the cell and the vertical axis represents the terminal voltage. As FIG. 3 shows, the relationship manifests sloping characteristics in which the terminal voltage (open circuit voltage) in a fully charged state (SOC 100%) is the highest and falls as the SOC is lowered. In the case of a lithium ion battery having its negative terminal constituted of hard carbon, the terminal voltage is approximately 4.1 V when the SOC is 100% and it falls to approximately 3.6 V when the SOC is 50%. Accordingly, the voltage generator circuit 41 is constituted so as to achieve a first target voltage V1 of 4.0 V and a second target voltage of 3.6 V.

The voltage detection signal output from the voltage detection circuit 31 is input to an input terminal T3 of the first voltage comparator circuit 211 and an input terminal T4 of the second voltage comparator circuit 212. Output terminals of the voltage comparator circuits 211 and 212 are both connected to a base terminal of the transistor 213. The voltage comparator circuits 211 and 212 each output an H-level signal when the level of the signal input to the respective input terminal T3 or T4 becomes higher than the level of the signal input to the corresponding reference terminal T1 or T2. In addition, the voltage comparator circuits 211 and 212 each output an L-level signal when the level of the signal input to the respective input terminal T3 or T4 becomes equal to or lower than the level of the signal input to the corresponding reference terminal T1 or T2.

The current bypass circuit 21 is structured so as to selectively utilize either the first voltage comparator circuit 211 or the second voltage comparator circuit 212. Namely, when the voltage control is to be implemented on the battery pack 1 over a range close to SOC 100%, a controller 42 issues instructions for the voltage generator circuit 41 to apply 4.0 V to the reference terminal T1 of the first voltage comparator circuit 211 and 5.0V to the reference terminal T2 of the second voltage comparator circuit 212. In this case, the level of the output signal from the first voltage comparator circuit 211 shifts in conformance to the level of the voltage detection signal input to the input terminal T3. Since the terminal voltage of a lithium ion battery never reaches 5V, the output signal from the voltage comparator circuit 212 keeps at L level. It is to be noted that the first voltage comparator circuit 211 and the second voltage comparator circuit 212 are structured so that the transistor 213 is driven as one voltage comparator circuit outputs an H-level signal even if the other voltage comparator circuit is currently outputting an L-level signal.

When the voltage control is to be implemented on the battery pack 1 over a range near SOC 50%, the controller 42 issues instructions for the voltage generator circuit 41 to apply 3.6V to the reference terminal T2 and apply 5.0 V to the reference terminal T1. In this case, the level of the output signal from the second voltage comparator circuit 212 shifts in conformance to the level of the voltage detection signal input to the input terminal T4. Since the terminal voltage of lithium ion battery never reaches 5V as explained earlier, the output signal from the first voltage comparator circuit 211 remains at L level.

The transistor 213 is turned on when either the first voltage comparator circuit 211 or the second voltage comparator circuit 212 outputs an H-level signal. When the transistor 213 is turned on, a bypass current flows via the resistor 214 and the transistor 213. The current bypass circuit 21 controls the bypass current of the cell 11 so as to equalize the terminal voltage Vc at the cell 11 to the voltage applied to the reference terminal T1 (or T2) of the currently selected voltage comparator circuit 211 (or 212).

The transistor 213 is turned off when both the first voltage comparator circuit 211 and the second voltage comparator circuit 212 outputs an L-level signal. As the transistor 213 is turned off, the bypass current of the cell 11 becomes cut off. At this time, the terminal voltage Vc at the cell 11 is either equal to or lower than the voltage applied to the reference terminal T1 (or T2) of the selected voltage comparator circuit 211 (or 212).

The first embodiment explained above is now summarized.

(1) The voltage control apparatus includes the current bypass circuits 21˜2n. If the terminal voltage of any of the cells 11˜1n reaches the first target voltage V1 (4.0V in the example) which is slightly lower than the voltage corresponding to a fully charged state (SOC 100%) while the battery pack 1 is charged, the charge current at the cell is bypassed. As a result, the charge current to the cell which has approached a fully charged state (SOC 100%) sooner than the other cells is decreased to slow down the process of the cell entering the fully charged state, and since this reduces the difference in the SOC between the cell and the other cells that are not charged as quickly, the inconsistency among the voltages at the individual cells is minimized. Thus, the discharge capacity of the battery pack 1 is not reduced and any cell degradation is prevented. The inconsistency in the SOC among the individual cells is caused by difference in characteristics of the individual cells which are brought during the cell manufacturing stage, varying temperatures at which the individual cells operate in the battery pack 1 and the like.

(2) Since a value slightly lower than the voltage value corresponding to the fully charged state (SOC 100%) is selected for the first target voltage V1, the bypass current stars to flow before the cell reaches SOC 100% to prevent the cell from becoming over charged. It is to be noted that the current bypass circuit has a function of bypassing the charge current and discharging the cell to lower the terminal voltage if the terminal voltage at the cell exceeds the target voltage.

(3) The second target voltage V2, which is different from the first target voltage V1, is also provided to allow the current bypass circuit 21 to selectively use either the target voltage V1 or the target voltage V 2. The target voltage V2 corresponds to SOC 50% and thus represents a terminal voltage which is often used in an actual application in a hybrid vehicle or the like. When the second target voltage V2 is selected and the terminal voltage of any of the cells 11˜1n reaches SOC 50%, the corresponding current bypass circuit 21˜2n bypasses the charge current at the cell. As a result, the charge current at the cell having neared SOC 50% sooner than the other cells is reduced, thereby slowing down the process of the cell reaching the state corresponding to SOC 50%. Therefore, the difference in the SOC between this cell and the other cells that are not charged as quickly is reduced in this manner, so that the inconsistency among the voltages at the individual cells is minimized. Thus, unlike in the related art that reduces the inconsistency among the voltages at the individual cells only over the range around SOC 100%, the inconsistency of the voltages at the individual cells is reduced over the range around SOC 50% as well. Consequently, since the inconsistency of the voltages can be reduced in correspondence to the state of charge of the battery pack 1, the discharge capacity of the battery pack 1 is not lowered and battery degradation is prevented.

(4) Since the battery pack is constituted of cells such as lithium ion cells that achieve sloping characteristic, as shown in FIG. 3, the SOCs of the individual cells can be uniformly adjusted by adjusting the terminal voltage (open circuit voltage) of each cell detected by the corresponding voltage detection circuit to the target value (the first target voltage V1 or the second part of voltage V2).

The current bypass circuit 21 should select the first voltage comparator circuit 211 while the system is engaged in operation (while the vehicle is traveling) and select the second voltage comparator circuit 212 while the system is in a non-operating state (while the vehicle is parked), for instance. For example, when the controller 42 receives a signal indicating a vehicle running state, the first target voltage V1 is set to be 4.0 V and the second target voltage V2 is set to be 5.0 V, so that the first voltage comparator circuit 211 is operated. On the other hand, when the controller 42 receives a signal indicating a vehicle parking state, the first target voltage V1 is set to be 5.0 V and the second v target voltage V2 is set to be 3.6 V, so that the second voltage comparator circuit 212 is operated.

### Second Embodiment

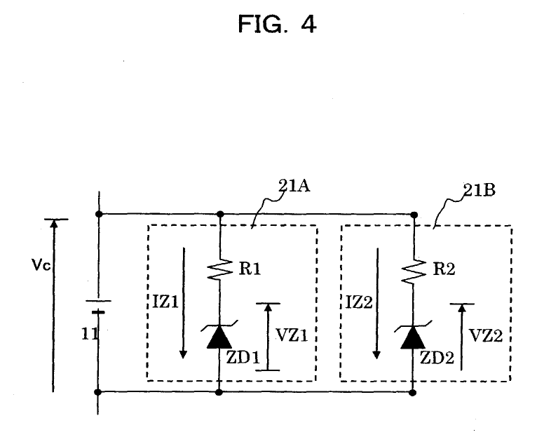

The current bypass circuits may be constituted by using Zener diodes. FIG. 4 is a circuit block diagram illustrating a current bypass circuit achieved in the second embodiment. In FIG. 4, a bypass circuit 21A and a bypass circuit 21B are individually connected in parallel to the cell 11. Bypass circuits identical to those shown in FIG. 4 are connected to the other cells as well. The bypass circuit 21A includes a resistor R1 and a Zener diode ZD1 connected in series to each other. The bypass circuit 21B includes a resistor R2 and a Zener diode ZD2 connected in series to each other. The second embodiment does not include any voltage detection circuits to engage the bypass circuits in operation.

The Zener diode ZD1 of the bypass circuit 21A has a breakdown voltage that corresponds to the first target voltage (4.0V) mentioned earlier. The resistance value of the resistor R1 is set so that the value of the current flowing to the Zener diode ZD1 when the SOC of the cell is 100% (when the terminal voltage at the cell is 4.1V) does not exceed the maximum rated current value of the Zener diode ZD1. A bypass current IZ1 achieved by the bypass circuit 21A adopting this structure is expressed as in formula (1) below.

IZ1=(Vc−VZ1)/r1 (1)

In the expression above, Vc represents the terminal voltage at the cell 11, VZ1 represents the breakdown voltage of the Zener diode ZD1 and r1 represents the resistance value of the resistor R1.

The Zener diode ZD2 of the bypass circuit 21B has a breakdown voltage that corresponds to the second target voltage (3.6V) mentioned earlier. The resistance value of the resistor R2 is set so that the value of the current flowing to the Zener diode ZD2 when the SOC of the cell is 100% (when the terminal voltage at the cell is 4.1V) does not exceed the maximum rated current value of the Zener diode ZD2. A bypass current IZ2 achieved by the bypass circuit 21B adopting this structure is expressed as in formula (2) below.

IZ2=(Vc−VZ2)/r2 (2)

In the expression above, Vc represents the terminal voltage at the cell 11, VZ2 represents the breakdown voltage at the Zener diode ZD2 and r2 represents the resistance value of the resistor R2.

In the current bypass circuit shown in FIG. 4, as the terminal voltage Vc at the cell rises until it exceeds the breakdown voltage VZ2, i.e., SOC 50% while the battery pack 1 is charged, the Zener diode ZD2 of the bypass circuit 21B enters an on state. As a result, the bypass current IZ2 flows via the resistor R2 and the Zener diode ZD2 and the terminal voltage Vc at the cell 11 becomes equal to the second target voltage V2.

As the terminal voltage Vc at the cell keeps rising and exceeds the breakdown voltage VZ1, i.e., a voltage level corresponding to an SOC slightly lower than 100%, the Zener diode ZD1 of the bypass circuit 21A is turned on. As a result, the bypass current IZ1 flows via the resistor R1 and the Zener diode ZD1 and the terminal voltage Vc at the cell 11 becomes equal to the first target voltage V1.

In the second embodiment, the bypass current IZ2 constantly flows once the terminal voltage Vc at the cell exceeds the voltage (3.6V) corresponding to SOC 50%. While this reduces the extent of inconsistency among the terminal voltages of the individual cells, it also lowers the charge efficiency. Accordingly, the bypass current IZ2 is set lower than the bypass current IZ1 by ensuring that the resistance value r1 and the resistance value r2 have a relationship expressed as r1<r2. As a result, the power consumption is reduced.

In the current bypass circuit, the resistance value r1 should be set as low as possible over the range in which the bypass current IZ1 does not exceed the maximum rated current value of the Zener diode ZD1. Since the bypass current IZ1 increases as the resistance value r1 is lowered, the cell can be quickly charged to the SOC 100% while being prevented from becoming over charged.

In the second embodiment described above, the inconsistency among the voltages at the individual cells can be reduced over the range around SOC 100% and over the range around SOC 50% as in the first embodiment. Since the inconsistency of the voltages can be reduced in conformance to the state of charge at the battery pack 1, the discharge capacity of the battery pack 1 is not lowered and cell degradation is prevented. In addition, since the Zener diode ZD1 (ZD2) is used and the voltage at which the bypass current starts to flow is set in conformance to the breakdown voltage of the Zener diode corresponding to the target voltage V1 (V2), the voltage detection circuit 31 for detecting the terminal voltage Vc is not required, thereby achieving a cost reduction over the structure which includes the voltage detection circuit 31.

The resistance value r2 of the resistor R2 may be variable. If the resistance value R2 is variable, the resistance value r2 can be set high during the system operation (while the vehicle is traveling) to prevent the system efficiency from becoming poor (to prevent the fuel efficiency from being compromised) by keeping down the bypass current IZ2. When the system is in a non-operating state (while the vehicle is parked), on the other hand, the resistance value r2 can be set low to prevent the inconsistency among terminal voltage Vc at an early stage by flowing the bypass current IZ2 actively. As a result, the inconsistency of the terminal voltages Vc is minimized at a restart of the vehicle to maximize the performance of the battery pack 1. It is to be noted that while the system is in a non-operating state, the resistance value r2 should be set to a value that enables a flow of the bypass current IZ2 which will eliminate any inconsistency among the terminal voltages Vc at the individual cells within a period of approximately 12 hours.

### Third Embodiment

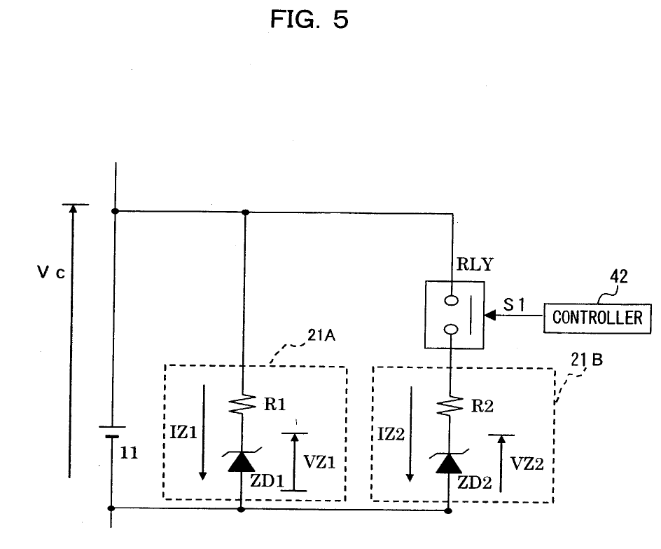

FIG. 5 is a circuit block diagram illustrating a current bypass circuit achieved in the third embodiment. It differs from the current bypass circuit in FIG. 4 in that an additional component, i.e., a relay RLY, is connected in series to the bypass circuit 21B. Bypass circuits identical to those shown in FIG. 5 are connected to the other cells as well. Open/close control is implemented on the relay RLY by using a drive signal S1 output from the controller 42.

The relay RLY is controlled so that it remains open while the system is in operation (while the vehicle is traveling). Thus, the bypass current IZ2 is cut off to prevent the fuel efficiency from becoming poorer. When the system is in a non-operating state (while the vehicle is parked), control is implemented on the relay RLY so as to allow it to remain closed. Since the bypass current IZ2 flows so as to reduce the inconsistency among the terminal voltages Vc, a state with little inconsistency of the terminal voltages Vc is achieved at a restart of the vehicle to maximize the performance of the battery pack 1. It is to be noted that the relay RLY should achieve characteristics whereby it closes when the drive signal S1 is not input (when no signal is input), since this eliminates the need to generate a drive signal for closing the rely RLY while the system is in a non-operating state.

The third embodiment explained above, in which the bypass current IZ2 is cut off by opening the relay RLY when the system is in operation (when the vehicle is traveling), does not allow the system efficiency to be lowered, i.e., does not allow the fuel efficiency to become poor, in addition to achieving the advantages of the second embodiment.

While an explanation is given above on an example in which the present invention is adopted in a hybrid electric vehicle (HEV), the present invention may also be adopted in a fuel cell vehicle (FCV).

In the explanation given above, the value of the target voltage V1 is set at the cell terminal voltage corresponding to a state close to the fully charged state (SOC 100%) and the value of the target voltage V2 is set to the cell terminal voltage corresponding to a state close to SOC 50%. However, the values of the target voltages do not need to be set in correspondence to the SOC values used in the example and may be set to other values as appropriate in correspondence to the normal SOC operating range. The number of target voltages does not need to be 2, and 3 or more target voltages may be set.

In addition, the voltage values (4.0V, 3.6V, etc.) quoted above are voltage values applicable to lithium ion cells and appropriate voltage values should be set in conformance to specific cell characteristics when other types of cells are utilized.

It is to be noted that components other than those used in the structures explained above may be adopted as long as the function characterized in the present invention is not compromised.

The disclosures of the following priority application are herein incorporated by reference: Japanese Patent Application No. 2002-00039 filed Jun. 12, 2002

What is claimed is:

1. A voltage control apparatus that controls a voltage of a battery pack constituted of a plurality of cells, comprising:
a plurality of voltage detection devices each detecting a voltage at each of the cells;
a plurality of first voltage adjustment devices each adjusting the voltage at each cell so as to achieve a first target value based upon the each voltage value detected by each of the voltage detection devices; and
a plurality of second voltage adjustment devices each adjusting the voltage at each cell so as to achieve a second target value based upon the each voltage value detected by each of the voltage detection devices.

2. A voltage control apparatus for a battery pack according to claim 1, wherein:
the first target value is set to a voltage lower than a voltage corresponding to a fully charged state of the cell by a predetermined value; and
the second target value is set to a voltage corresponding to a state of charge (SOC) of the cell in a normal operating range.

3. A voltage control apparatus for a battery pack according to claim 1, further comprising:
a controller that controls either the first voltage adjustment device or the second voltage adjustment device to be selectively operated.

4. A voltage control apparatus for a battery pack according to claim 3, wherein:
the controller controls the second voltage adjustment devices to adjust the voltage at each cell when a system to which power from the battery pack is supplied is in a non-operating state.

5. A voltage control apparatus for a battery pack according to claim 4, wherein:
the system is either a hybrid electric vehicle or a fuel cell vehicle.

6. A voltage control apparatus for a battery pack according to claim 1, wherein:
the cells each achieve sloping characteristics whereby the voltage thereof becomes lower as a state of charge (SOC) thereof falls.

7. A voltage control apparatus that controls a voltage of a battery pack constituted of a plurality of cells, comprising:
a plurality of first circuits each connected in parallel to each cell and constituted of a first Zener diode having a first breakdown voltage and a first resister connected in series to the first Zener diode, and
a plurality of second circuits each connected in parallel to each cell and each constituted of a second Zener diode having a second breakdown voltage smaller than the first breakdown voltage and a second resister connected in series to the second Zener diode.

8. A voltage control apparatus for a battery pack according to claim 7, wherein:
the first breakdown voltage is a voltage lower than a voltage corresponding to a fully charged state of the cell by a predetermined value; and
the second breakdown voltage is a voltage corresponding to a state of charge (SOC) of the cell in a normal operating range.

9. A voltage control apparatus for a battery pack according to claim 7, wherein:
the first and second resisters are configured such that the current in the first circuit is greater than the current in the second circuit.

10. A voltage control apparatus for a battery pack according to claim 7, further comprising:
a switch having an open state and a closed state,
when the switch is opened, no current in the second circuit flows and when the switch is closed, current in the second circuit flows.

11. A voltage control apparatus for a battery pack according to claim 10, further comprising:
a controller that controls the switch to be opened or closed.

12. A voltage control apparatus for a battery pack according to claim 11, wherein:
the controller controls the switch to be closed when a system to which power from the battery pack is supplied is in a non-operating state.

13. A voltage control apparatus for a battery pack according to claim 12, wherein:
the system is either a hybrid electric vehicle or a fuel cell vehicle.

14. A voltage control apparatus for a battery pack according to claim 13, wherein:
the cells each achieve sloping characteristics whereby the voltage thereof becomes lower as a state of charge (SOC) thereof falls.

15. A voltage control apparatus that controls a voltage of a battery pack constituted of a plurality of cells, comprising:
a detection means for detecting a voltage at each of the cells;
a first adjustment means for adjusting the voltage at each cell so as to achieve a first target value based upon the voltage value detected by the detection means; and
a second adjustment means for adjusting the voltage of the cell so as to achieve a second target value different from the first target value based upon the voltage value detected by the detection means.
